(19) United States
(12) Patent Application Publication
(10) Pub. No.: US 2012/0303401 A1
(43) Pub. Date: Nov. 29, 2012

(54) FLEXIBLE WORKFLOW TASK ASSIGNMENT SYSTEM AND METHOD

(75) Inventors: Karl E. Tolgu, Seattle, WA (US); Babak Nakhayi Ashtiani, Redmond, WA (US); Ramesh Gururaja, Sammamish, WA (US); Anthony F. Bernard, Woodinville, WA (US); Josh Honeyman, Bellevue, WA (US); Sukumar Rathnam, Sammamish, WA (US)

(73) Assignee: MICROSOFT CORPORATION, Redmond, WA (US)

(21) Appl. No.: 13/117,751

(22) Filed: May 27, 2011

(51) Int. Cl. G06Q 10/00

(52) U.S. Cl. 705/7.13

(57) ABSTRACT

Enterprise systems, methods and computer program products are disclosed for facilitating a flexible assignment of tasks to work item queues according to assignment rules and conditions for a business document. The system comprises associating an application object server response to a client workflow form or control, associating an expression to an assignment rule or condition with the work item queue and creating a default work item queue for an expression or series of ordered expressions that do not evaluate true. During runtime, the flexible workflow task assignment process evaluates the sequence of ordered expressions for a given work item queue until no next expression is to be evaluated and assigning the task to the default work item queue.

### FIELD OF THE INVENTION

The present invention generally relates to enterprise computer systems and methods and more particularly to systems, methods and computer program products for facilitating flexible workflow task assignment to a work item queue for a member of an enterprise according to an assignment rule or set of assignment rules.

### BACKGROUND

In today's technological environment, it is common for enterprises such as business organizations, schools, charitable organizations and government organizations to deploy private computer networks—intranets—to securely share such an enterprise's information or network operating system within that enterprise. The term “intranet” is used in contrast to “internet”, which is a network between and among individuals and enterprises, the most common of which is the global, public Internet. That is, an intranet is a network within an enterprise which sometimes refers only to an internal (private) website, but may be a more extensive part of the enterprise's information technology (IT) infrastructure. For example, in many enterprises, a member or an employee may work from home and gain access to the enterprise via a portal requiring additional security hurdles such as synchronous keys for entry. An enterprise intranet may host multiple private websites and constitute an important component and focal point of internal communication with, and collaboration among, individual computer users associated/affiliated with the enterprise (e.g., students within a university, co-workers within a company, members of a governmental department or the like).

As individual computer users associated/affiliated with the enterprise perform various computer-based activities while logged into the intranet, these users may utilize enterprise resource planning (ERP) client/server systems as provided by the enterprise. One such system known as the Dynamics ® AX 2009 ERP system available from Microsoft Corporation of Redmond, Wash. provides an enterprise workflow infrastructure among other features. Fundamentally, workflows consist of one or more workflow activities that represent items of work to be completed and involve an interrelationship between a human and a system, for example, with respect to a document which may be referred to herein as a business document. An example of a business document may be a purchase requisition for parts, products or services or the minutes of a board of directors meeting. Structured workflow activities may result in this known system by organizing a workflow runtime through an application object server (AOS) framework including communications, messaging, tracking, work items, expressions, configurations and metadata. A given business document such as a purchase requisition may require all of these: communications, messaging, tracking and the like. A given business document may have a structured human workflow. A workflow runtime structure may monitor a constant stream of, for example, message communications related to a particular workflow business document or related process and generally assist in controlling the workflow for the given business document. Similarly, a project or inventory management or other elements of an enterprise may require workflow management. By workflow management is intended the execution of automated business processes by a workflow infrastructure, for example, surrounding a business document.

In another context, that of planning for accomplishment of workflow activities in a timely manner to assure completion of an overall project, a so-called critical path method of analysis of a project is known which identifies the activities required to reach a common completion date for a project and assigns certain durations to each activity. This critical path method involves creating a list of all activities required to complete the project, estimating the time or duration that each activity will take to completion and identifying the dependencies between the activities. From practicing the method, one may determine the earliest and latest that each activity can start and finish without making the project longer.

Human workflow systems may incorporate the use of various assignment methods for tasks that the system may generate and the users to perform the tasks. One such method involves the ability to assign tasks to a workflow work item queue (or queue of work items, tasks or activities) rather than directly to a person. The term workflow work item queue will be more simply referred to herein as a work item queue. This work item queue approach is analogous to an assembly line in which a pool of workers surrounds a bin of unfinished goods. A worker can grab an item from the bin and finish it and move the finished goods to the next bin of the assembly line. In a business document or project related scenario, people, herein users, act on their tasks (to finish the unfinished goods) via their membership in the pool of surrounding users, i.e., membership of the work item queue. Configuring workflow to directly assign tasks or processes to a single specific work item queue provides limited flexibility. It may require the workflow to be reconfigured every time there is a change in the work item queue (in the extreme, when the bin is empty or is overflowing).

Thus, it may be known to provide enterprise workflow structure to certain activities, to identify activities, tasks or work items related to a business document's completion processes such as by using the critical path method) and to create a work item queue, but, given the foregoing, what are needed are more flexible systems, methods and computer program products for adapting existing workflow set-up and project planning runtime applications to determine an appropriate work item queue to assign a task using an assignment rule surrounding the created or selected work item queue out of a group of possible work item queues and establish a default work item queue when necessary.

### SUMMARY

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by setting up and providing run-time systems, methods and computer program products for adapting existing workflow and runtime applications, for example, related to a business document to determine appropriate work item queue to assign a task using an assignment rule surrounding the appropriate work item queue or set of rules for a group of related work item queues, for example, to a business document such as a purchase requisition.

In an embodiment, a set of assignment rules may be defined that may be based on a specific business document type. The assignment rules may be defined in the form of expressions such as business document requirements, for example, for processing a purchase requisition of a given type and having less than a predetermined monetary value. Given the expression being true for the task, then, an available work item queue from a plurality of available work item queues may be selected or one created and an assignment rule expressed. In a further embodiment, multiple sets of expressions and work item queue combinations may be created and ordered as a set or group. For instance, with the purchase requisition example, there may be certain requirements for one value of purchase requisition and different, more stringent requirements for a higher value of purchase requisition. These different assignment rules for purchase requisitions of different value may become a set of assignment rules/expressions for the given business document, a purchase requisition. Each set of assignment rules then may be assigned to a related group of work item queues.

In a further embodiment, a work item queue assignment may be selected at runtime such that the activated workflow locates and evaluates each assignment rule of an ordered set of assignment rules sequentially until “true” is returned and a work item queue selected. The workflow task or work item created, for example, for a business document comprising a purchase requisition for $2500, may require processing by a manager level employee, and so may be assigned to a work item queue associated with manager level employees. When “true” is returned for the expression of the ordered set of expressions for one value, then, one work item queue with manager level membership is selected, while, for example, the next rule/expression may require director level processing for a higher value purchase requisition and so on. A manager level employee may access the work item queue for processing one value of purchase requisition and a director level employee may access the work item queue for the higher value purchase requisition. The manager level and director level processing requirements form rules dictating selection of work item queues in sequence.

In a further embodiment, a flexible work item queue assignment using a business rule further includes a default work item queue if no other work queue returns a “true” or matches the ordered set of expressions. This default work item queue is accessible by employees with permission to access and so determine handing of tasks that are assigned to the default work queue. As defined herein, such a person may be identified herein as an administrator or owner of a work item queue.

In order to sa-up such a flexible workflow task assignment process, a method comprises creating and activating a work hem queue and, as necessary, a work item queue group. This may include defining a business document or workflow form and its assignment rules/conditions for completion of processing. Once a work item queue is created and activated, the method further comprises creating work item queue assignment rules. This may include defining as many instances of “true” assignment rules required for assignment to a work item queue as possible. Users may be added to one or more work item queues. Once the several work queues and expressions are defined and created, the set-up process further may comprise selecting or creating a “default” work item queue whereby, when the defined set of expressions, for example, for a given business document, are not returned “true,” the default work item queue is selected and the task assigned to the default work item queue. Now that all work item queues and the default work item queue are defined, one may configure the workflow to use flexible work item queue assignment. A final process of set-up of flexible workflow with assignment rules is making the workflow available for use, in a work item for a given business document may be submitted by a business user and processed accordingly.

A run-time environment of the configured flexible work item queue assignment process comprises evaluating a next assignment rule expression in a sequence of an ordered set of assignment rules. For example, an assignment rule may be related to processing a purchase requisition business document having a predetermined value. If the result of the expression is true, then, the task is assigned to the work item queue for the current expression. Then, a decision is made whether there exists additional assignment rules of an ordered set of assignment rules. If YES, then these are tested for True, for example, a next higher value level purchase requisition. The process proceeds until all expressions have been tested and tasks assigned to work item queues or the task is assigned to a default work item queue because no expressions have tested True.

Further features and advantages of the present invention, as well as the structure and operation of various embodiments of the present invention, are described in detail below with reference to the accompanying drawings.

### BRIEF DESCRIPTION OF THE DRAWINGS

The features and advantages of the present invention will become more apparent from the detailed description set forth below when taken in conjunction with the drawings in which like reference numbers indicate identical or functionally similar elements.

FIG. 1 is a block diagram illustrating an exemplary intranet client server enterprise system according to an embodiment of the present invention wherein client devices may gain access to an application object server directly or via a report server, a host server or a web server; the application object server, in turn may access a database server.

FIG. 2 is a flowchart illustrating an exemplary workflow forms and controls process according to an embodiment of the present invention wherein a client renders workflow forms and controls and sends requests back to an application object server of FIG. 1 as a result of user interaction with the forms and controls.

FIG. 3 is a block diagram of an exemplary computer system useful for implementing the present invention either as a client of FIG. 1 or 2 or server of FIG. 1 or 2.

FIG. 4A is a set-up process for a flexible workflow work item assignment process involving work item queues with assignment rules including setting up a default work hem queue according to an embodiment of the present invention; FIG. 4B is an exemplary user interface for creating a new work item queue group of work item queues or selecting from existing work item queues to create a group; FIG. 4C is an exemplary user interface for creating work item queues and for assigning users to a particular work item queue, for example, for urgent purchase requisition review of a purchase requisition review process; FIG. 4D is a further exemplary user interface of FIG. 4B showing that a Headquarters Queues work item queue has been created and described and is associated with selected work item queues Normal priority purchase requisition review and Urgent purchase requisition review; FIG. 4E provides an exemplary user interface for a Work item queue assignment rule, in particular, having a pop-up screen portion for creating a high value purchase requisition work item queue assignment rule; FIG. 4F provides an exemplary user interface for Work item queue assignment rule and for definition of a condition such as an amount in excess of a predetermined value for the high value purchase requisitions assignment rule of FIG. 4E; FIG. 4G provides an exemplary user interface for Purchase requisition review showing flexible workflow for assignment rules for assigning users to the workflow element Review purchase requisitions.

FIG. 5 is a run-time process for a flexible assignment of tasks to a work item queue or to a default work item queue according to assignment rules/conditions in the form of an ordered set of same illustrating an exemplary assignment to a given work item queue for a given assignment rule or to a default work item queue according to an embodiment of the present invention.

FIG. 6A is an exemplary chart showing work assignment rules and assignment of work items to a work item queue in accordance with the dynamic run-time process of FIG. 5.

FIG. 6B is a further exemplary chart showing formation of an assignment rule table, a work item queue expression and a workflow item queue where the workflow item queue is existing and the formation of expressions is in accordance with the present invention.

### DETAILED DESCRIPTION

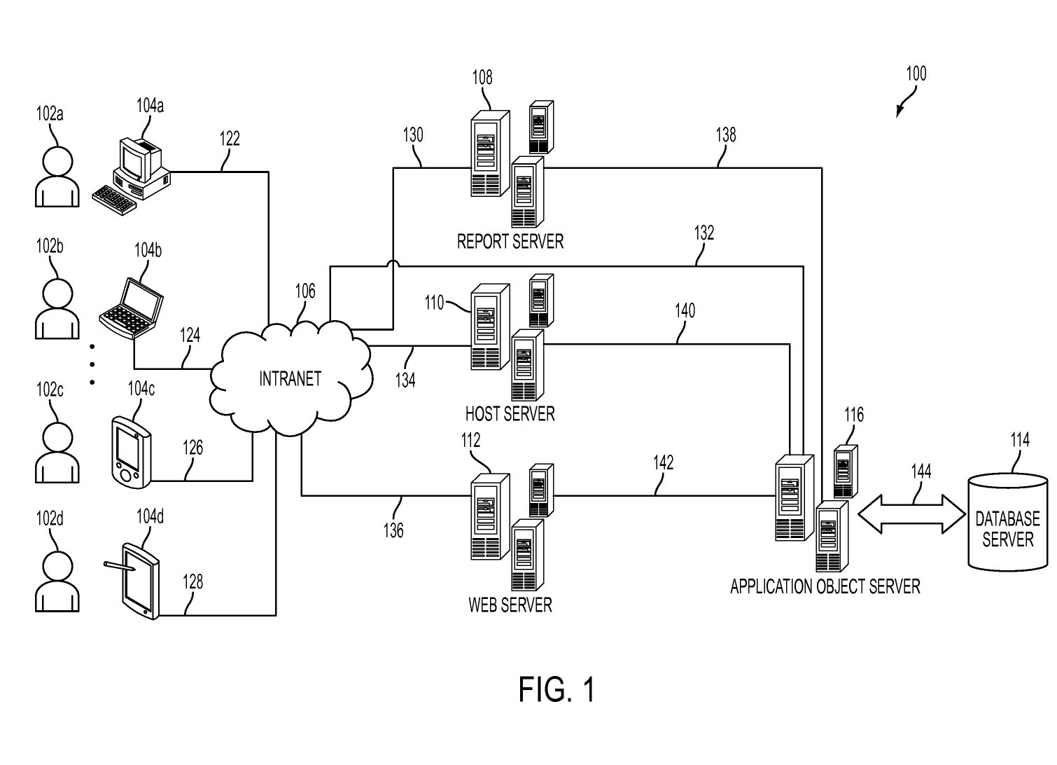

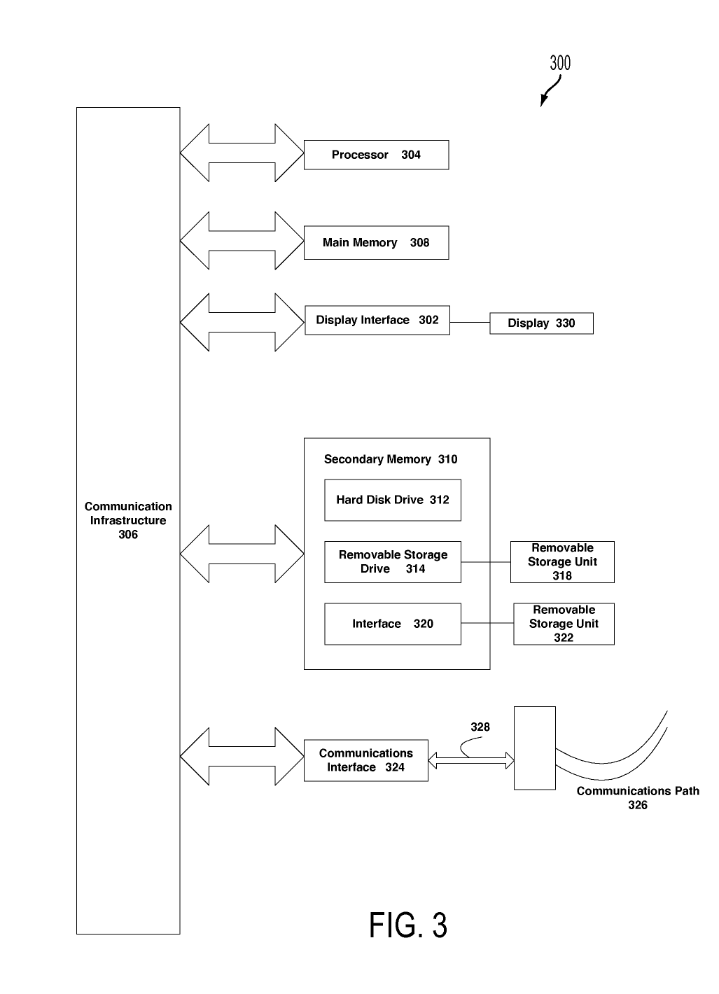

The present invention is directed to flexible systems, methods and computer program products for facilitating the collection, consolidating, storing and exposing of data within a computer network (especially an intranet) to allow for flexible workflow work item assignment according to assignment rules/conditions and the associated formation of a set of assignment rules and their expressions, for example, for a given business document associated with assignment rules/conditions associated with that business document. Firstly, FIG. 1 and FIG. 3 will be described depicting exemplary hardware on which a flexible workflow task assignment according to assignment rules/conditions in the form of expressions may be implemented as a computer implemented method on a depicted client and servers.

Referring first to FIG. 1, a block diagram illustrating an exemplary intranet activity data collection system 100 for an enterprise, according to an embodiment of the present invention, is shown.

Intranet flexible workflow task assignment system 100 includes a plurality of users 102 (shown as users 102a-d in FIG. 1) of an organization accessing, via a respective computing device 104 (shown as devices 104a-d in FIG. 1), an organization's intranet (i.e, private network) 106. Computing device 104 may be described herein as an organizational or enterprise member client. As will be appreciated by those skilled in the relevant art(s) after reading the description herein. Intranet 104 may be a private network deployed by an organization or enterprise such as a business enterprise for use by its employees. An enterprise system may, by way of example, be one for a university for use by its students and faculty, one for a government agency for its workers, and the like. As will also be appreciated by those skilled in the relevant art(s) after reading the description herein, system 100 may be deployed across one or more jurisdictions as, for example, a multinational business enterprise makes its intranet 106 available to its employees around the world. This would thus subject system 100 to a plurality of national, state and/or local privacy laws and regulations that are applicable in such one or more jurisdictions in which intranet 106 spans. For example, in the event of purchase requisition values for goods or services above a certain value, an enterprise may be required to enter into competitive bidding and assure that women or minority owned enterprises are afforded an opportunity to respond to a request for proposal.

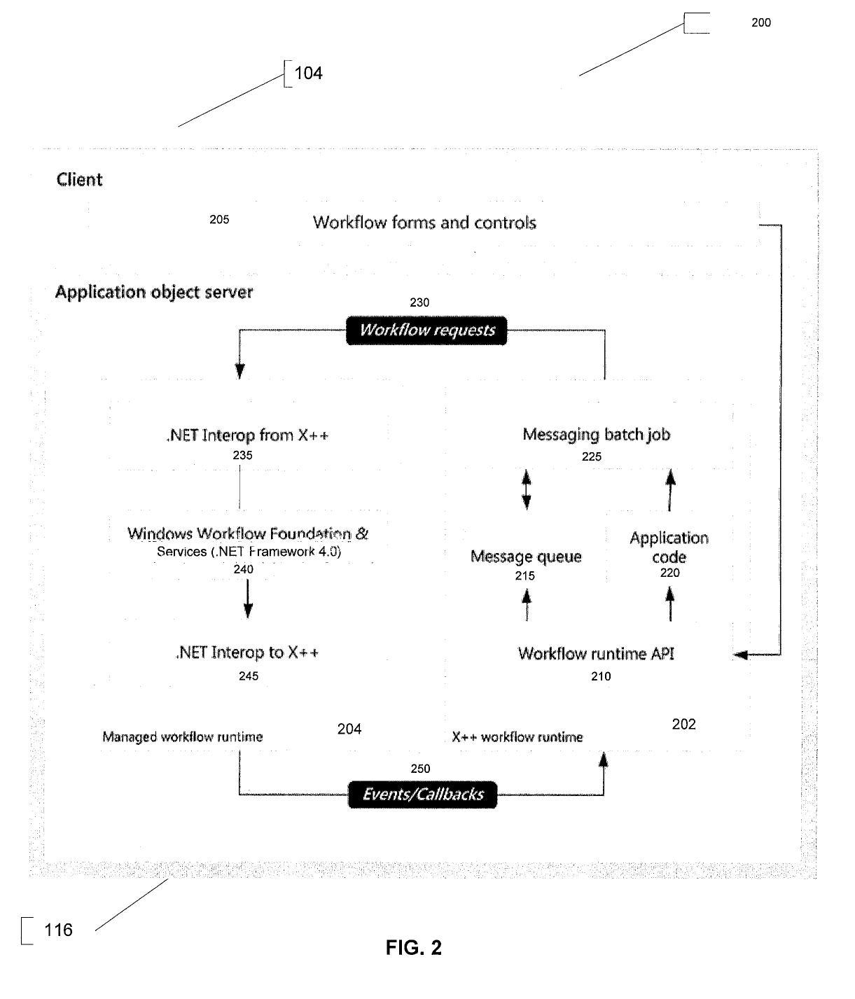

In various embodiments, device 104 may be configured as a desktop 104a, a laptop 104b, a PDA 104c, a tablet or mobile computer 104d, an intelligent communications device or the like. Device 104, in order to access private network or intranet 106 may typically have to identify a user name and password, if not, enter further security information such as a secret key or fingerprint data to access intranet network 106. In accordance with an embodiment of a method of flexibly assigning workflow tasks or work items to work item queues at the request of an identified organization member by user name and password, the user name and password may be utilized by any of servers 108, 110 and 112 to access an application object server 116 or application object server 116 may be accessed directly by a client 104 as will be described further herein with reference to FIG. 2.

FIG. 1 also shows communications media 122 for a desktop computer, 124 for a laptop, 126 for an intelligent mobile device, and 128 for a tablet computer. Communications media may be of any known form, wireless or wired, fiber optic, coaxial cable, satellite and the like and utilized at any location in an intranet network 106 (or internet) including media 130, 132, 134, 136, 138, 140, 142 and 144 to connect clients to servers, servers to servers and the like. Not all communications media or locations of intranet or other network 106 are shown to simplify FIG. 1, but comprise communications media and network connections known in the art.

As users 102 log into an organizational/enterprise intranet 106, they perform various computer-based tasks while logged into the organization/enterprise's intranet 106. Thus, there are constant streams of activities occurring such as navigating to URLs, opening and editing business documents, writing, opening and reading email and/or instant messages, and the like. These may be considered active processes of the organization member. All these data may be allocated into categories, for example: data and commands associated with setting up a process for flexible workflow assignment and operating a runtime application to automatically assign work items or tasks to work item queues or to a default work item queue as will be further described herein. With reference to FIG. 1, an enterprise server herein referred to as an application object server 116 may comprise a Dynamics® AX server running software available from Microsoft Corporation of Redmond. Washington. Oracle. IBM and other manufacturers of enterprise systems may provide similar workflow services with less workflow functionality with their software product lines.

Referring now to FIG. 2, a workflow forms and controls process is shown by way of example for Dynamics AX. A client 104 may render workflow forms and controls 205 which may be received at Workflow runtime application programming interface (API) 210 of X++ workflow runtime 202. In particular, if there happens to be a call to workflow in a set of requests at application object server 116, then the Workflow runtime API 210 will be called. Workflow runtime API 210 may receive requests from the workflow-enabled forms and controls 205 from client 104. X++ workflow runtime 202 outputs Workflow requests 230 via message queue 215, application code 220 and messaging batch job 225 from Workflow runtime API 210 to Managed workflow runtime 204 of an application object server 116. Managed workflow runtime 204 may comprise .NET Interop from X++ 235. Windows ‘Workflow Foundation & Services (NET Framework 4.0) 240 and .Net Interop to X++ 245.

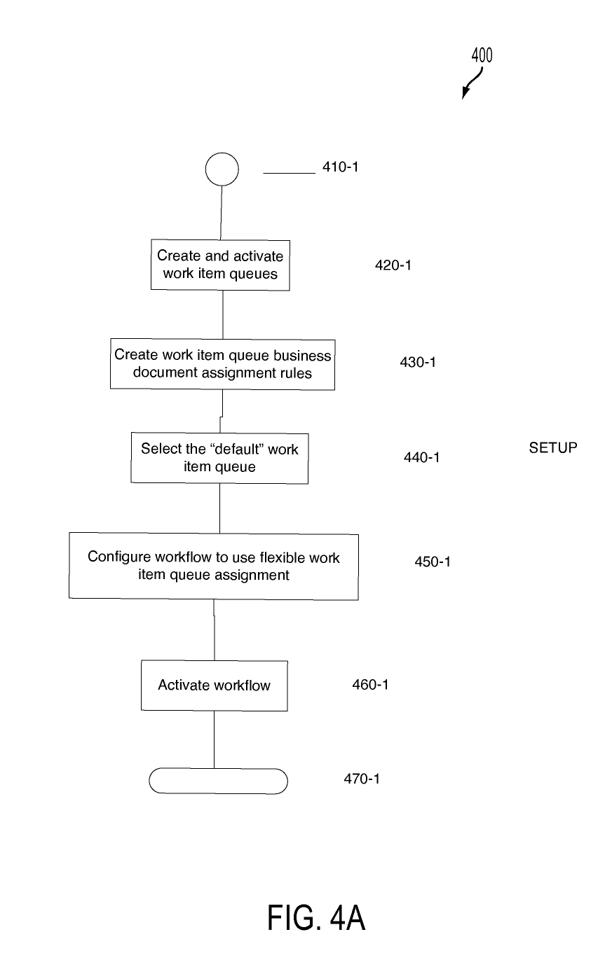

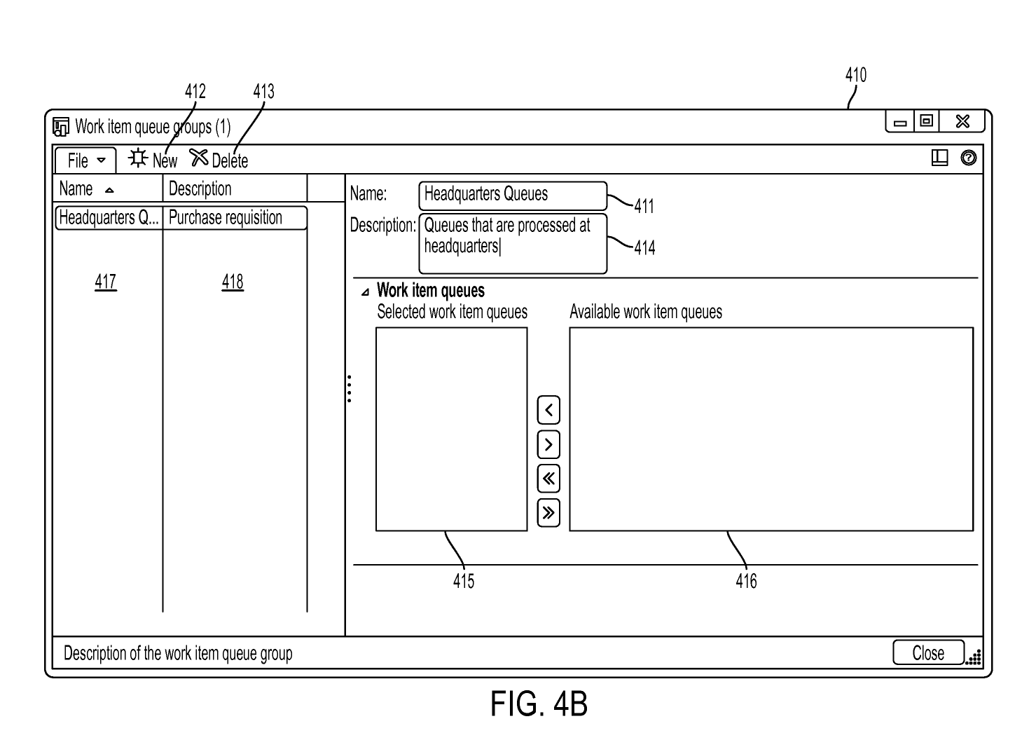

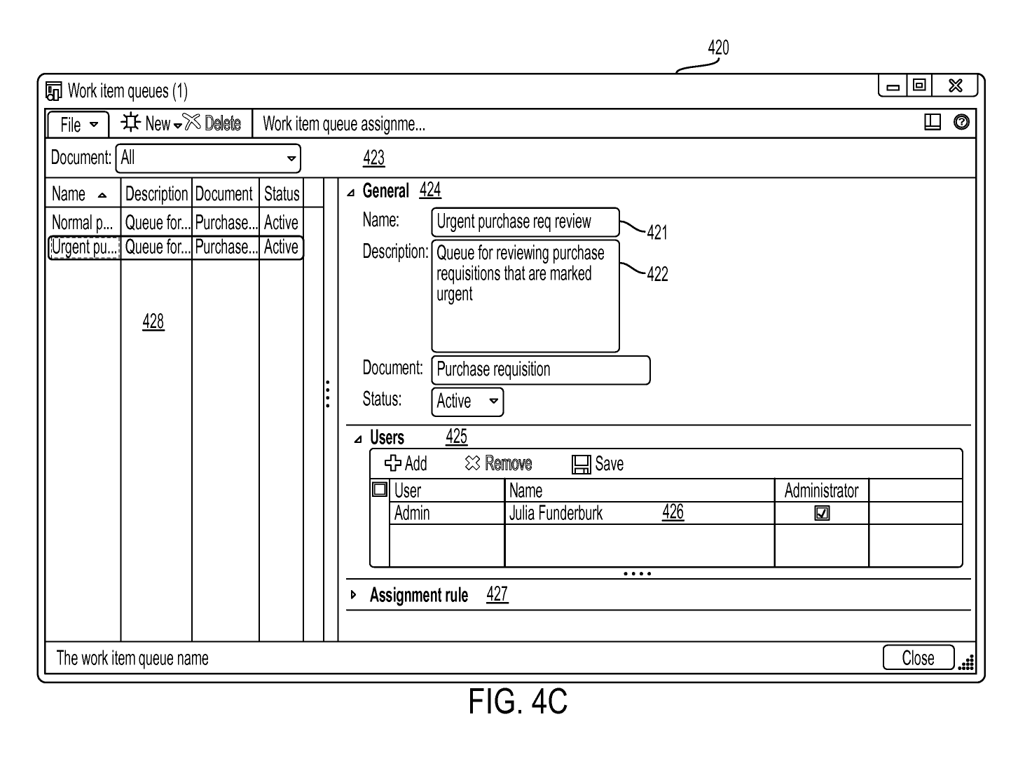

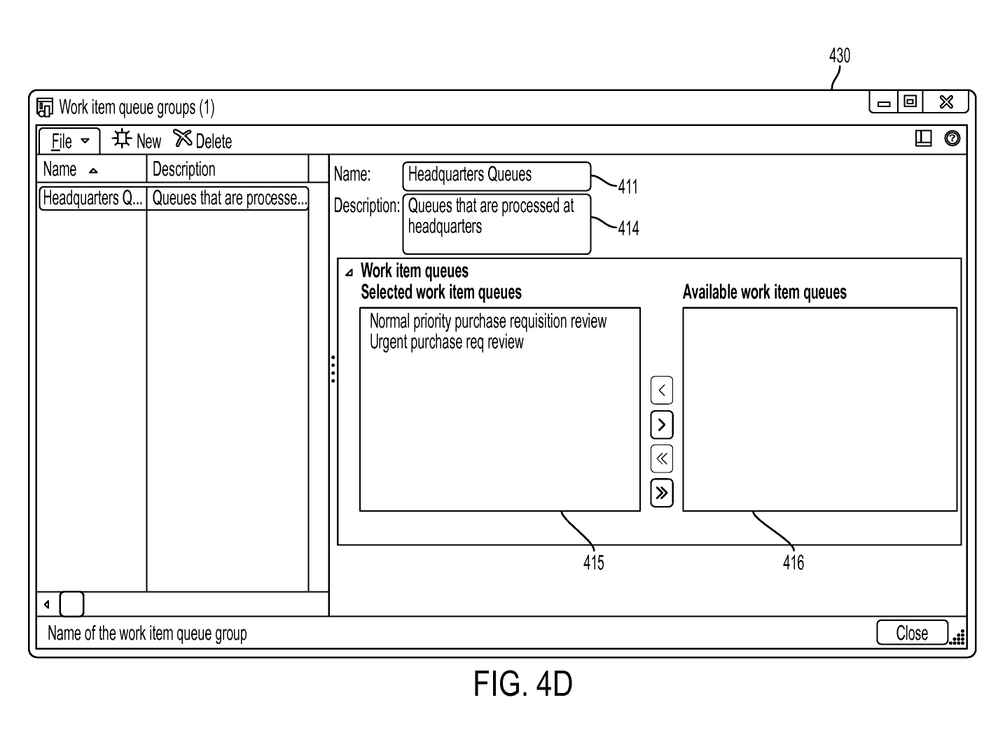

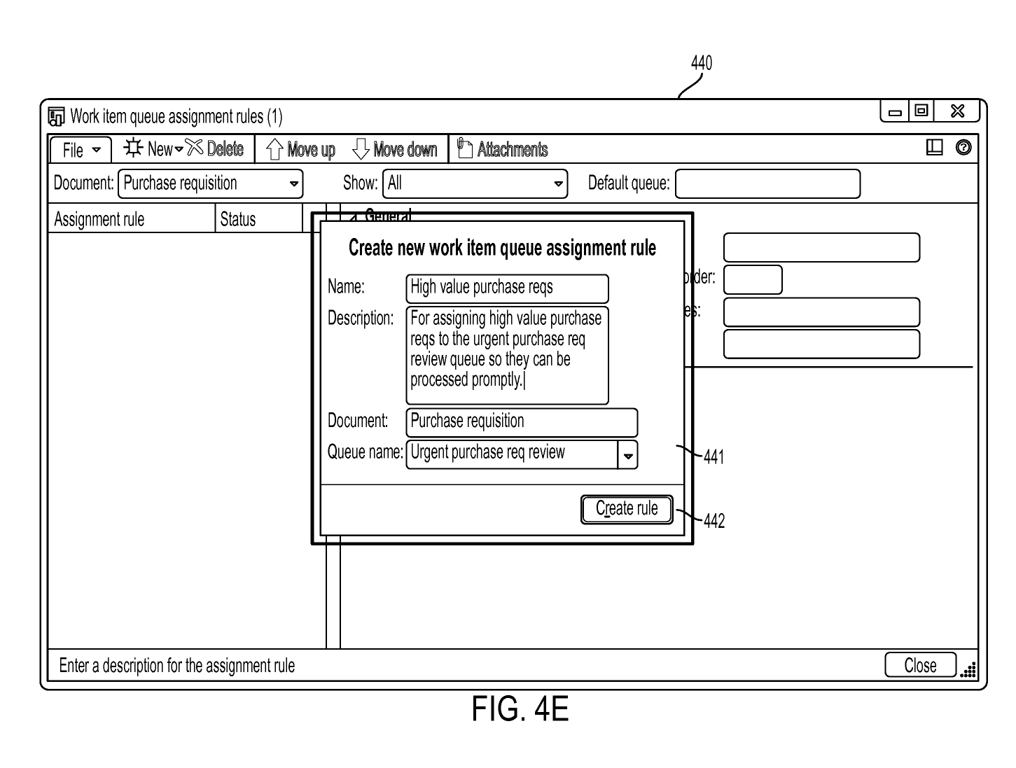

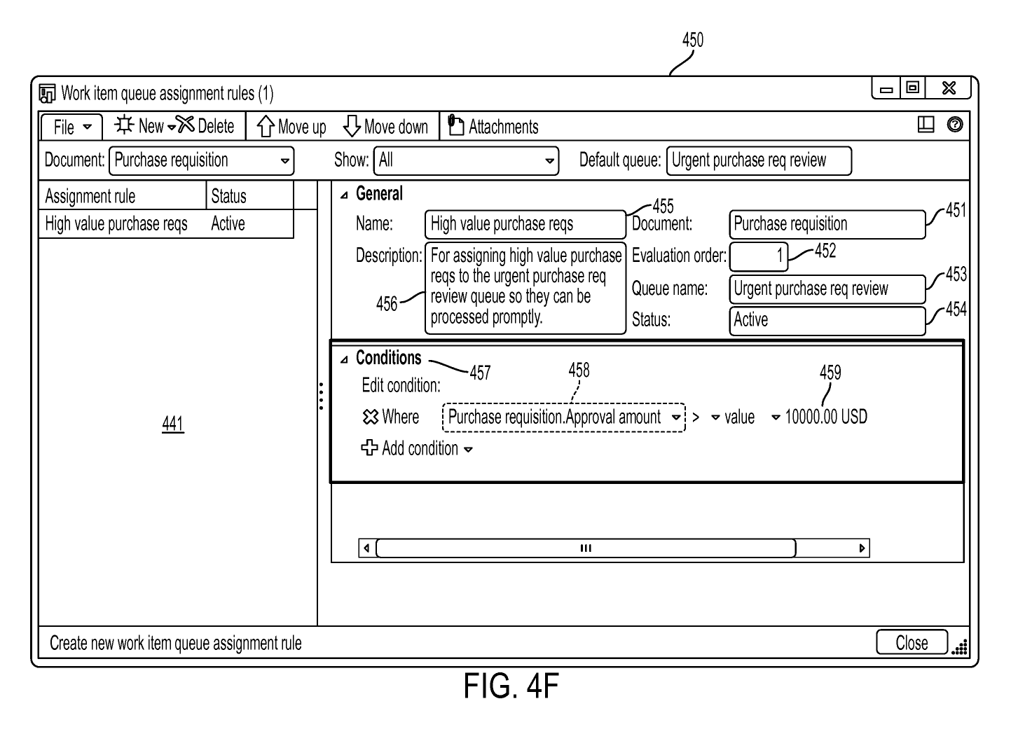

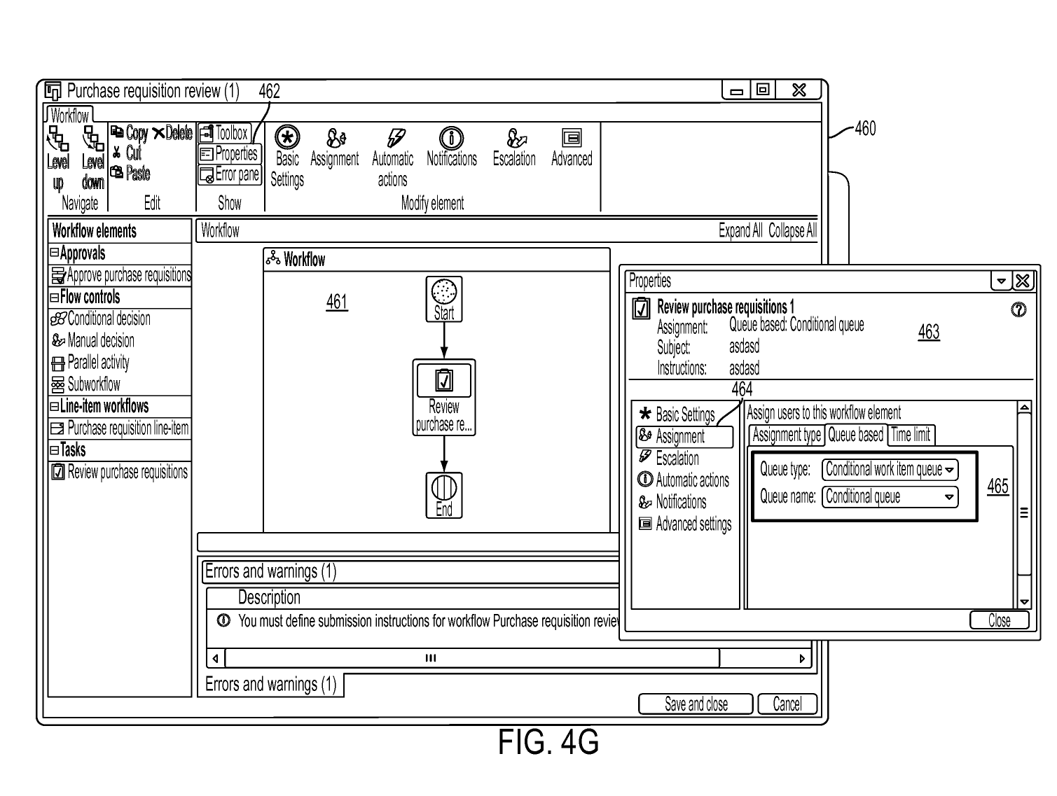

X++ may a special programming language similar to a managed language such as C# used with Dynamics AX. (Other programming languages may be used as well, for example, C++ and related languages, wherein X++ is described herein by way of example.) Continuing the discussion of FIG. 2, X++ workflow runtime 202 may comprise a workflow runtime API 210 for receiving requests from the workflow-enabled forms and workflow controls 205 from client 104. Workflow runtime API 202 may interface with parallel paths to messaging batch job 225 via a message queue 215 and application code 220. Messaging batch job 225 outputs workflow requests 230 to managed workflow runtime 204. Managed workflow runtime 204 receives workflow requests 230 at .NET interop from X++ 235 from the X++ workflow runtime 202. WINDOWS (or other operating system) workflow foundation and Microsoft Dynamics AX (or other enterprise software application) extensions may output to .NET Interop to X++ 245 (or other language interop such as C++). Managed workflow runtime 204 in turn outputs events and callbacks 250 to X++ workflow runtime 202 as per FIG. 2. Thus, events/callbacks 250 received at an x++ workflow runtime 202 form a loop with workflow requests 230 that may be received at managed workflow runtime 204. The process may continue with additional form and control requests from clients 104 as a flexible workflow management system according to FIG. 4. System 100 thus further provides for specific handling of workflow forms and control requests from each client 104. As will be discussed herein, client 104 may be a client of a member of a work item queue, an owner or administrator of a work item queue or a person responsible for setting up work item queues which have assignment rules defined to control which work items are assigned to which work item queues in accordance with FIG. 4.

In an alternate embodiment to FIG. 2, application object servers 116 may employ a web server 112 (e.g., the SHAREPOINT® web platform available from Microsoft Corporation of Redmond, Wash.) or a host server 110 to allow intranet administrators and clients to manage flexible workflow assignment. For example, such a web server 112 can be used as a base and can allow for complete configuration and monitoring of system 100 such as the location of log files, access credentials, privacy and business rules, data filtering and the like.

In an alternate embodiment, an intranet administrator would have access to configuration, status and data retrieval server 114 via, a web service-based application programming interface (API) (e.g., Simple Object Access Protocol (SOAP) or RESTful). In such an embodiment, the intranet administrator may enforce privacy laws and business rules based on access credentials. For example, an unprivileged user might be allowed to retrieve the total number of specific documents being accessed within intranet 106, while an authorized user (a manager or director or owner of a work item queue) may retrieve more detailed information such as which user 102 accessed certain documents and when. This allows privacy protection while storing complete and detailed information as permitted by applicable privacy laws and business rules.

In various embodiments, configuration, status and data retrieval servers 114 allow for built-in support for enforcing privacy laws and business rules, including facilities for the following:
1. Access rules which define who can access the data, the documents and in which way (e.g., detailed versus anonymized).
2. Exclusion Inclusion) rules which define groups of users 102 or data sources from which workflow should not be performed (or performed in the case of inclusion rules for other groups of users 102 or data sources). For example, private data for users 102 from the organization's legal department. C-level executives and the like can be excluded from flexible workflow assignment to protect privileged/sensitive information. Or, certain activity, organizational hierarchy and distribution list data for users from a particular graphical location can be excluded if privacy laws at that location prohibit or restrict category or partial category data collection. Sites which are considered “high business impact” can be also excluded (e.g., based on data automatically collected from directory service information or web content management application servers). On the other hand with respect to inclusion rules, data may be collected for other groups of specified users 102 or data sources to be included.
3. conditions may be conditions at a given client site that preclude, limit or encourage flexible workflow assignment. Examples of conditions may be conditions within an enterprise such as client users not available on a given day or conditions external to an enterprise such as an extreme weather day that may preclude or limit flexible workflow task assignment. Conditions may involve predictable events such as heavy order seasons such as holiday or weather-related demand for product or services (for example, a need to stock snow shovels during a snow storm.)
4. Consent rules allows users 102 to have notice of policies and practices of a given work item queue for, for example, a given document. Consent may take several forms: Opt-in consent where user 102 has to take an affirmative action before data is collected or an action or command for a given form may be permitted; or Opt-out consent where user 102 can take an affirmative action to prevent the collection of data before that data is collected. An organization member may, for example, elect to not participate or participate in a limited manner in flexible workflow task assignment and the like.

An example of a computer system 300 is shown in FIG. 3 which may either represent a client or a server of FIG. 1 or FIG. 2.

Computer system 300 includes one or more processors, such as processor 304. The processor 304 may be connected to a communication infrastructure 306 (e.g., communications bus or network). Various software aspects are described in terms of this exemplary computer system. After reading this description, it will become apparent to a person skilled in the relevant art(s) how to implement the invention using other computer systems and/or architectures. Computer system 300 may represent a client device 104 possessed by an organization/enterprise member 102. Computer system 300 may similarly represent a server 108, 110, 112, 114 or 116 as introduced in FIG. 1 and components thereof.

Database server 114 may be a SQL or other database server responsible for maintaining for example documents, organization charts, inventory data documents and the like for an enterprise (herein, business documents). As such, as a business document is processed such as a purchase requisition, workflow work item queue assignment rules and the like may be retrieved by application object server 116 for use in workflow management.

Computer system 300 can include a display interface 302 that forwards graphics, text and other data from the communication infrastructure 306 (or from a frame buffer not shown) for display on the display unit 330. A display interface may be what a user 102 sees on any one of devices 104. A user may type or click or use other form of data or command entry to input data/commands to a flexible workflow task assignment system according to assignment rules of the present invention.

Computer system 300 also includes a main memory 308, preferably random access memory (RAM) and may also include a secondary memory 310. The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner. That is, removable storage unit 318 may represent a floppy disk, magnetic tape, optical disk, etc. which is read by and written to by removable storage drive 314. As will be appreciated, the removable storage unit 318 may include a computer usable storage medium having stored therein computer software and/or data.

In alternative aspects, secondary memory 310 may include other similar devices for allowing computer programs or other instructions to be loaded into computer system 300. Such devices may include, for example, a removable storage unit 322 and an interface 320. Examples of such may include a program cartridge and cartridge interface (such as that found in video game devices), a removable memory chip (such as an erasable programmable read only memory (EPROM), or programmable read only memory (PROM)) and associated socket and other removable storage units 322 and interfaces 320, which allow software and data to be transferred from the removable storage unit 322 to computer system 300.

Computer system 300 may also include a communications interface 324. Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of non-transitory signals 328 that flow over communications media 122, 124, 126, 128, 130, 132, 134, 136, 138, 140, 142 and 144 among others, not shown, which may be electronic, electromagnetic, optical or other signals capable of being received by communications interface 324. These signals 328 are provided to communications interface 324 via a communications path (e.g., channel) 326. This channel 326 of communications media 328 carries media signals 328 and may be implemented using wire or cable, fiber optics, a telephone line, a cellular link, an radio frequency (RF) link and other communications channels as explained above.

In this document, the terms “computer program medium” and “computer usable medium” are used to generally refer to media such as removable storage drive 314, a hard disk installed in hard disk drive 312 and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage units 318, 322, removable storage drive 314, hard drive 312 or interface 320 of secondary memory 310. The control logic (software when executed by the processor 304, causes the processor 304 to perform the functions of the invention as described herein.

Referring now to FIG. 4A, there is shown an exemplary set-up process for setting up a work item queue workflow using assignment rules/conditions translated into expressions, for example, that may be evaluated as True. Process 410-1 represents the start of set-up whereby business users of a workflow system of an enterprise may set up a work item queue who may know a business process being automated but may not know how to code. These business users may activate a workflow involving assignment rules and conditions without knowing for example, any programming tools such as X++ or C# programming languages and the like as will be discussed with reference to exemplary client interface screens FIGS. 4B-4G. The -1 in process 410-1 indicates that start 410-1 may involve a number of elements not shown or explicitly discussed but may be inferred or otherwise known from the description.

Screens of FIGS. 4B-4G are related to FIG. 4A as follows. The steps of an exemplary user interface differ slightly from those of FIG. 4A and comprise: 1. Create a workflow work item queue group; 2. Create one or more workflow work item queues for a specific business document where one may add users to a queue and enable the queue; 3. Add the workflow work item queues to the queue group created in step 1; 4. Add workflow work item queue assignment rules and 5. Enable conditional queue assignment for a task element in a workflow. Step 1 is exemplified by FIG. 4B; step 2 by FIG. 4C; step 3 by FIG, 4D; steps 4 by FIGS. 4E and 4F; and step 5 by FIG. 4G.

Referring now to process 420-1, there is shown a process of creating and activating a work item queue which may be associated with a business document. A work item queue, for example, may typically be associated with a workflow form or business document process such as a purchase requisition review process shown in exemplary screens FIGS. 4B-4G. It may likewise be associated with any workflow task associated, for example, with a process surrounding a business document where a purchase requisition is only used by way of example. There are innumerable and countless business documents and associated processes in an enterprise. One such process may involve business documents surrounding the research and development of new products and services, another may be business documents for the control of manufacturing processes, another may be the business document workflow associated with marketing a product and then the sale of a product or service. There may be a workflow associated with business documents for maintaining an inventory for a particular product in relation to volume.

Work item queues typically have enterprise members or users associated with them. These may, for example, comprise users capable of and having the authority to perform a task allocated to a work item queue. There may be an owner or administrator of a queue, someone in an enterprise responsible for efficient operation of the work item queue in accordance with the assignment rules and conditions. This individual may assign more enterprise members to a work item queue during heavy demand periods and decrease membership for a work item queue during periods of sparse demand. The owner or administrator may have the authority to create a related work item queue, place a queue on hold, inactivate a queue or modify an existing work item queue from a client device 104 in communication with an application object server 116.

Referring briefly to FIG. 4B, there is shown an exemplary user interface referred to as a work item queue group screen 410. This screen may comprise a create button 412 and a delete button 413 for creating and deleting work item queue groups. A work item queue group may comprise a headquarters queues group 411 which a business user may complete and describe as “Queues that are processed at headquarters.” Note that Name entry 411 corresponds to “Headquarters Q . . . ” in Name column 417 and Description column 418 reads “Purchase requisition” as the description. As will be further described, the business user of exemplary screens FIGS. 4B-4G is defining a purchase requisition review process and Purchase requisition description 418 conforms to that process.

Referring briefly to FIG. 4C, there is shown an exemplary user interface referred to as a work item queue screen 420. Screen 420 shows a General portion 424, a Users portion 425 and an Assignment rule portion 427. Under General 424, the name of the work item queue may be Urgent purchase req review 421 and its description 422 is “Queue for reviewing purchase requisitions that are marked urgent.” The business document for the work item queue may be a purchase requisition document and the queue is Status active, which may be a selectable parameter. Users 425 includes identification 426 of Julia Funderburk as administrator by check mark. User may also be selected. At 428, “All” documents are identified as purchase requisition related and the Names are “Normal priority purchase requisition review” and the present “Urgent purchase req review may be highlighted or otherwise designated.

Referring briefly to FIG. 4D, there is shown a further exemplary work item queue group screen interface 430 similar to that of FIG. 4B. By now. Name Headquarters Queues 411 and Description “Queues that are processed at headquarters” 414 are identified as associated with the following, selected Work item queues 415: Normal priority purchase requisition review and Urgent purchase req review. There are no available work item queues 416.

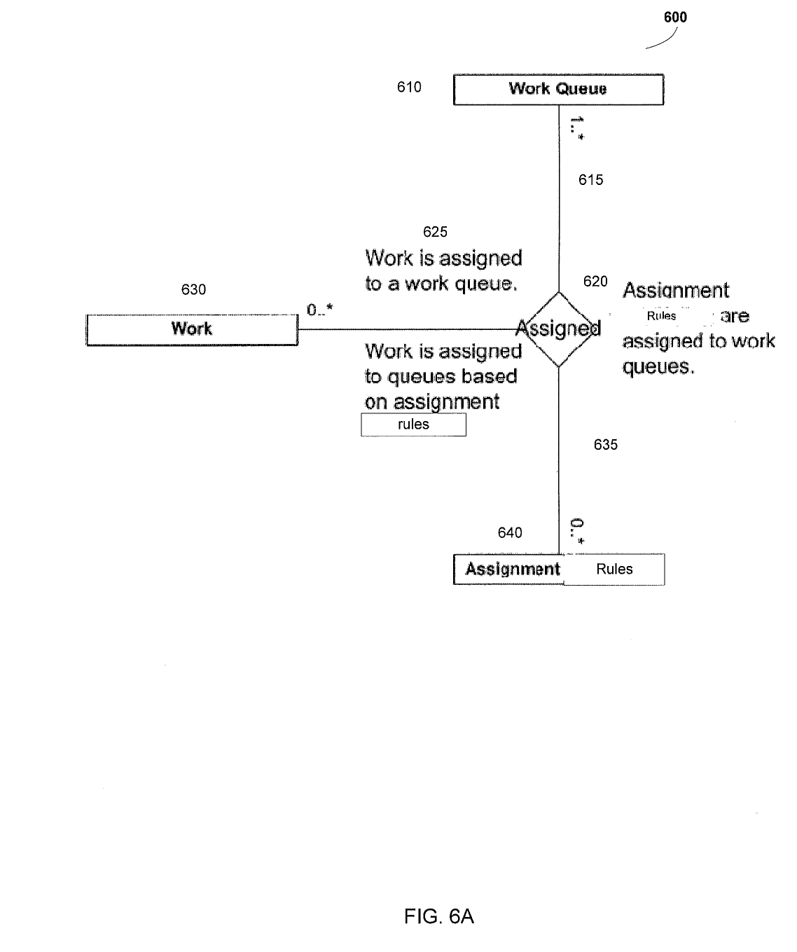

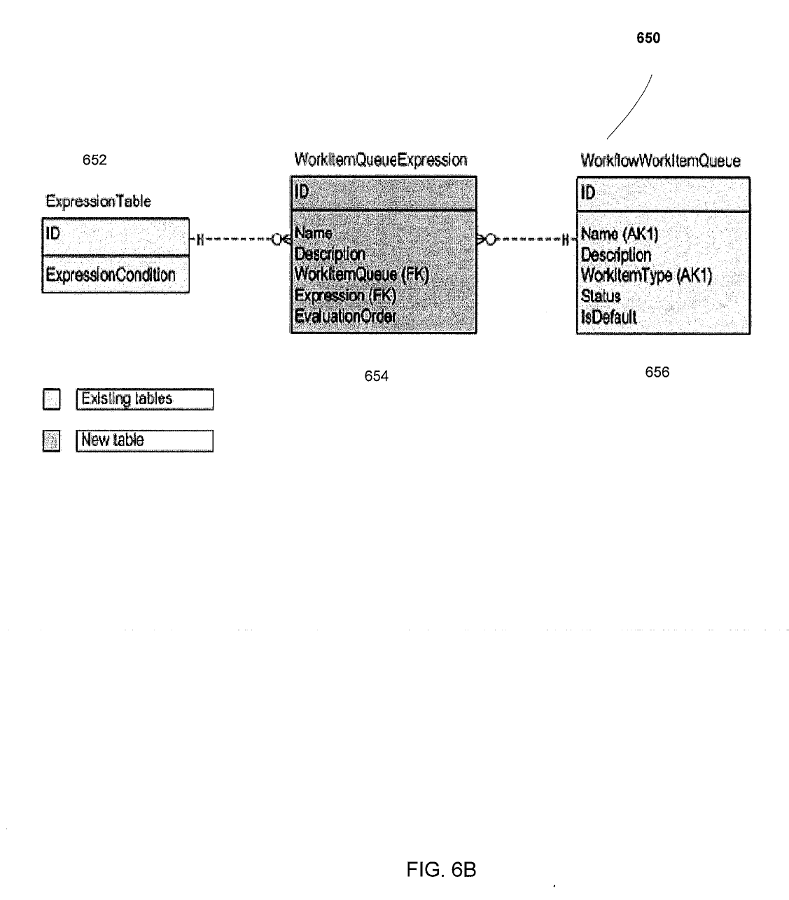

Referring briefly to FIG. 6A, a process 430-1 is thither exemplified by the depicted process 600. Here, work 630 is analyzed by a business user authorized to establish a work item queue 600. As a further process, assignment rules 640 are evaluated involving expressions as defined above. At assignment decision 620, assignment rules are input via 635 and work 630 input via path 625 such that 1) a work item is assigned to a work item queue, 2) work item is assigned to a work item queue based on assignment rules and 3) assignment rules/expressions are assigned to work item queues. The result of assignment box 620 is a path 615 to the creation of a work item queue 610. Now, in addition, per process 420-1, not only is a work item queue created, the resultant work item queue may be activated so that it may comprise a viable work item queue for flexible workflow task assignment as will be discussed further herein.

Referring back to FIG. 4A, set-up next involves process 430-1 which is the creation of a set of -workflow assignment rules and associated expression for the work item queue. These are, for example, expressions that evaluate true and sequentially apply to a work task or work item and a business document such as a purchase requisition. For example, associated with the screens of FIGS. 4B-4G), a purchase requisition may have a value less than $2500 and require a manager to process. A purchase requisition valued at $10,000 may require a director to process. A related expression may be: is the value of the purchase requisition greater than $10,000, if True, then, it is assigned to a director work item queue to process. If Use, the flow may be to a next expression such as a less than $10,000 value or $2500 for a manager queue. One can see that these expressions may comprise an ordered set of sequential assignment rules in the form of expressions such that as each is evaluated, and if the answer is not True, one may proceed to the next evaluation.

Referring now to FIGS. 4E and 4F, exemplary screens for a new work item queue assignment rule will be described conforming to process 430-1 of FIG. 4A. Referring first to FIG. 4D, the underlying screen 440 is a Work item queue assignment rule screen related to Document: Purchase requisitions. A default queue (process 440-1 of FIG. 4A) has not yet been selected or created. When New is selected on the screen 440, there may be a pop-up or other screen display or display portion display entitled: “Create new work item queue assignment rule.” This screen portion comprises Name. Description. Document and Queue name fields 441 and Create rule button 442. In particular, an assignment rule for an Urgent purchase req(uisition) review work item queue may be for assigning high value purchase req(uisition)s to the urgent purchase req(uisition) review queue so they can be processed promptly. Note that the rule may be written by a business user without knowing code.

Once create rule 442 is selected, one may proceed to FIG. 4F which conforms to FIG. 4E as both relating to High value purchase re(uisition)s assignment rule creation. Screen 450 contains a General screen portion with Name 455 (High value purchase req(usitition)s), Description 456 (For assigning high value purchase req(uisition)s to the urgent purchase req(uisition) review queue so they can be processed promptly), and Document 451 again indicates that this process is about a purchase requisition document. Also, part of the assignment rule process is setting Evaluation order 452 at 1. Queue name 453 as Urgent purchase req(uisition) review 453 and Status 454 as active.

Referring to FIG. 6B, there are shown a succession of tables 650 from Dynamics AX. A similar table or succession of tables may be provided in a similar workflow system of a similar enterprise system. An Expression Table 652 may comprise an identifier ID and an associated Expression Condition or assignment rule. Following the ID path, the Expression Table leads to a WorkItemQueueExpression 654 by ID developed for the condition or assignment rule. Here, the expression may have a plurality of keys to other tables: Name. Description. WorkItemQueue, Expression and EvaluationOrder. Of these, for example, the EvaluationOrder may provide an order in an ordered set of identified expressions. Name, Description and Evaluation order or not intended to be keys in this context. The WorkItemQueueExpression 654 may lead to WorkflowWorkItemQueue 656 which provides the following: Name, Description, WorkItemType, Status and IsDefault. Of these WorkItemQueueExpression may be a new table and ExpressionTable and WorkflowWorkItemQueue may be existing tables. In this manner an expression, its queue and status may be defined by way of tables. Other forms of expression definition may be utilized in other enterprise systems.

Referring back to FIG, 4, a next process 440-1 is associated with forming/selecting a default work item queue which would follow if expressions of the ordered set of expressions are not satisfied. One may select a default work item queue from an existing work queue set or create a new work item queue having its own owner or administrator. The owner or administrator of the default work item queue my evaluate the work and conditions and establish or select an appropriate default work item queue.

Referring again to FIG. 4F, screen 450, the Default work item queue is selected and named as Urgent purchase req review. The choice of this work item queue as a default queue may relate to the assignment rule. Continuing the discussion of FIG. 4F, there is shown a Conditions screen portion 457. This conditions portion may comprise Edit condition. One may be selected as a Where expression or a condition may be added. In screen 450, there is shown Where Purchase requisition.Approval amount 458>selectable value and selectable 10000.00 USD 459.

Referring again to FIG. 4A, once all work item queues and a default work item queue are established, then, set-up flow passes to process 450-1 wherein the workflow may be configured to use flexible work item queue assignment rules. Exemplary screen 460 of FIG. 4G shows a Review purchase req process 461 activated with all condition/rule assignments in place for work queues and default work queues. When properties 462 is selected. Properties pop-up display portion 463 may appear for Review purchase requisitions 1 and where Assignment 464 is selected to show assignment of users to this workflow element and tabs Assignment type. Queue based and Time limit are selectable with Queue based 465 shown to display Queue type: Conditional work item queue and Queue name: Conditional queue. Process 460-1 of FIG. 4A indicates activation of the workflow in conformity to the set-up screens, for example. FIG. 4A to 4G and others not shown. Process 470-1 represents a termination of set-up.

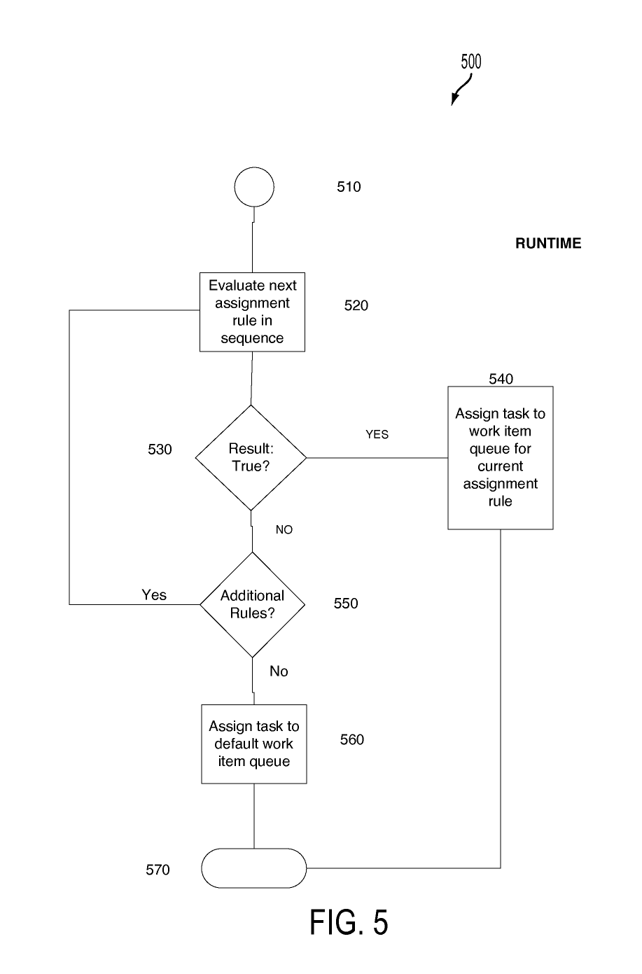

Referring now to FIG. 5, there is shown a runtime flowchart 500 illustrating a runtime process for sequentially evaluating assignment rules in the form of expressions for a given business document of a flexible workflow task assignment process.

Referring first to process 510, this process 510 represents the beginning of runtime. Next referring to process 520, there is shown a first/next evaluation of an expression in sequence as, for example, defined by evaluation order of Evaluation order 452 of screen 450 or table 654 of FIG. 6B. The process 530 asks the question whether the expression evaluates True, for example, for a first purchase requisition value of, for example, a value over $10000. If True, or Yes, the process 540 assigns the task to a work item queue, for examples, for manager level processing and the process terminates for that task at box 570. On the other hand, if the result is not True at box 530, additional expressions of an ordered sequence of evaluations are evaluated. If there are additional expressions, for example, a purchase requisition valuation of less than $10,000, headquarters processing, urgent processing and the like, then, evaluation occurs at 520. The loop continues until either all expressions of assignment rules are evaluated and the work items assigned to work item queues or the answer at 550 is returned No. If no, then, the task is processed at 550: assign the task to a default work item queue 560. Once all tasks are assigned to either work queues for the current expression 540 or a default work queue assigned 560, the process 500 terminates.

In the one embodiment, a flexible assignment of workflow tasks or work items according to assignment rules or conditions is embodied in the form of either a client-based application or a server-based application such that a special purpose computing device results from the installation or downloading of a related software application. In another embodiment, the invention may be implemented primarily in hardware using, for example, hardware components such as application specific integrated circuits (ASICs), special purpose devices and servers. Implementation of a hardware state machine so as to perform the functions described herein will be apparent to persons skilled in the relevant art(s).

As will be apparent to one skilled in the relevant art(s) after reading the description herein, the computer architecture shown in FIGS. 1 and 3 may be configured as a desktop, a laptop, a server, a tablet computer, a PDA, a mobile computer, an intelligent communications device or the like. Any of these may be under the personal control of an organization or enterprise member, intranet administrator and the like and may be operated transparent to other workflow processes, for example, for data entry of inventory data, purchase requisition data, request for proposal data, marketing and sales data and related organizational hierarchy data as well as other data relevant to the automatic assignment of tasks to work queues according to ordered sets of rules/conditions.

In yet another embodiment, the invention is implemented using a combination of both hardware and software.

While various aspects of the present invention have been described above, it should be understood that they have been presented by way of example and not limitation. It will be apparent to persons skilled in the relevant art(s) that various changes in form and detail can be made therein without departing from the spirit and scope of the present invention. Thus, the present invention should not be limited by any of the above described exemplary aspects, but should be defined only in accordance with the following claims and their equivalents.

In addition, it should be understood that the figures in the attachments, which highlight the structure, methodology, functionality and advantages of the present invention, are presented for example purposes only. The present invention is sufficiently flexible and configurable, such that it may be implemented in ways other than that shown in the accompanying figures. For example, the systems, methods and computer program products for facilitating the collection of intranet document data while complying with applicable laws and regulations and business policies disclosed herein are also applicable to other networks such as internets.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present invention in any way.

What is claimed is:

1. A computer-implemented method configured to set up a flexible assignment of a task to a work item queue in an enterprise, the method comprising:
retrieving one of business document data and assignment rule data in response to a request for one by a first member of the enterprise;
creating a work item queue related to the business document or assignment rule data in response to data retrieving;
creating a work item queue expression for the activated work item queue responsive to one of the business document data and the assignment rule data for the work item queue;
creating or selecting a default work item queue for the created work item queue; and
activating the workflow comprising the activated work item queue and the default work item queue.

2. The computer-implemented method of claim 1, further comprising:
assigning an administrator to the work item queue.

3. The computer-implemented method of claim 1, further comprising:
assigning a user to the work item queue.

4. The computer-implemented method of claim 1, wherein creating a work item queue expression comprises creating an ordered set of work item queue expressions from the assignment rule data.

5. The computer-implemented method of claim 1, wherein work item queue creation comprises assignment of a work item to a work item queue, assignment of a work item to a work item queue based on an assignment rule and assigning assignment rules to work item queues.

6. The computer-implemented method of claim 1, wherein creating an expression comprises a sequence of tables; the tables comprising an expression table including an expression condition; a work item queue expression table including an evaluation order and a workflow work item queue table comprising status.

7. The computer-implemented method of claim 1, wherein creating a work item queue comprises receiving data at a work item queue group interface for selecting work item queues of a group of work item queues.

8. The computer-implemented method of claim 1 comprising creating a work item queue assignment rule.

9. The computer-implemented method of claim 8 comprising one of editing a condition and adding a condition for the created work item queue assignment rule.

10. A computer-implemented method configured for runtime operation of a flexible assignment of a task to a work item queue in an enterprise, the method comprising
evaluating an expression for an assignment rule or condition associated with a task for a business document;
if the expression is evaluated True, assigning the task to a work item queue for the expression and if false, evaluate a next expression of an ordered set of expressions;
repeating evaluating and assigning so long as there is a next expression to evaluate;
if there is no next expression to evaluate, assigning the task to a default work item queue.

11. The computer-implemented method of claim 10 for implementation on an application object server, the application object server including a workflow runtime application programming interface to a client device.

12. The computer-implemented method of claim 11 for implementation on an application object server, the workflow runtime application programming interface for receiving requests from the client device.

13. The computer-implemented method of claim 10 comprising receiving evaluation order data via an assignment rule user interface.

14. A computer program product comprising computer usable medium encoded in a computer having control logic stored therein for causing the computer to set up a flexible assignment of a task to a work item queue in an enterprise, said control logic comprising:
first computer readable program code means for retrieving one of business document data and assignment rule data in response to a request for one by a first member of the enterprise;
second computer readable program code means for creating a work item queue related to the business document or assignment rule data in response to the first computer readable program code means and activating the created work item queue;
third computer readable program code means for creating a work item queue expression for the activated work item queue responsive to the business document or assignment rule data and assigning the work item queue expression to the work item queue; and
fourth computer readable program code means for creating or selecting a default work item queue for the created work item queue.

15. The computer program product of claim 14, further comprising:
fifth computer readable program code means for assigning an administrator to one of a work item queue and a default work item queue and users to the work item queue.

16. The computer program product of claim 14, further comprising a workflow runtime application programming interface for receiving workflow forms and controls from a client.

17. The computer program product of claim 14, further comprising means for displaying a client user interface for receiving user input comprising the business document and assignment rule data.

18. A computer program product comprising computer usable medium encoded in a computer having control logic stored therein for causing the computer to provide runtime operation of a dynamic assignment of a task to a work item queue in an enterprise, said control logic comprising
first computer readable program means for evaluating an expression for an assignment rule or condition associated with a task for a business document;
if the expression is evaluated True, second computer readable program means for assigning the task to a work item queue for the expression and if false, evaluate a next expression of an ordered set of expressions;
third computer readable program means for repeating evaluating and assigning so long as there is a next expression to evaluate;
if there is no next expression to evaluate, fourth computer readable program means for assigning the task to a default work item queue,

19. The computer program product of claim 18, further comprising fifth computer readable program code means for assigning an administrator to one of a work item queue.

20. The computer program product of claim 8, further comprising means for creating or selecting the default work item queue.
